(19) United States
(12) Patent Application Publication
(10) Pub. No.: US 2015/0306977 A1
(43) Pub. Date: Oct. 29, 2015

(54) CONTROL DEVICE FOR A VEHICLE SEAT

(71) Applicant: Johnson Electric S.A., Murten (CH)

(72) Inventors: Yi Yong WU, Shenzhen (CN); Ping LIU, Shenzhen (CN); Xiao Ming WANG, Hong Kong (CN)

(21) Appl. No.: 14/697,061

(22) Filed: Apr. 27, 2015

(30) Foreign Application Priority Data
Apr. 25, 2014 (CN) 201410172778.0

(51) Int. Cl. B60N 2/02; H02P 7/00

(52) U.S. Cl. CPC B60N 2/0232; H02P 7/0094; B60N 2/0244

(57) ABSTRACT

A control device for a vehicle seat includes at least one motor for adjusting the seat, a sampling circuit for generating a ripple signal indicative of a rotational number of the motor, a converter for converting the ripple signal to a pulse signal which has the frequency proportional to the ripple signal, and a controller for counting the pulses in the pulse signal such that seat position information can be determined.

### CROSS REFERENCE TO RELATED APPLICATIONS

This non-provisional patent application claims priority under 35 U.S.C. §119(a) from Patent Application No. 201410172778.0 filed in The People's Republic of China on Apr. 25, 2014, the entire contents of which are hereby incorporated by reference.

### FIELD OF THE INVENTION

This invention relates to a control device for a vehicle seat.

### BACKGROUND OF THE INVENTION

In vehicles some seats have electric motors arranged inside and thus the seat position can be adjusted by the motors. The adjustment is usually made based on the current position information of the seat. For this purpose, rotational information, such as rotational number and rotational direction, of the motors need be determined. The rotational number refers to the number of revolutions of the motor and may be equal to or proportional to the actual number of revolutions.

In a known system, Hall sensors are used to sense the rotation of the rotors of the motors and the controller of the vehicle determine the rotational information of the motors based on the signals output by the Hall sensors. As the Hall sensors must be mounted close to the motors, wires for the Hall sensors are required between the motors and the controller, which increases the number of long wires inside the vehicle body and makes the control system heavier and more expensive when the motors and the controller are remote from each other.

### SUMMARY OF THE INVENTION

Accordingly, in one aspect thereof, the present invention provides a control device for a vehicle seat, comprising: an electric motor for adjusting the seat; a sampling circuit for generating a ripple signal indicative of a rotational number of the motor; a converter for converting the ripple signal to a pulse signal which has a frequency proportional to the frequency of the ripple signal; and a controller for counting pulses in the pulse signal such that seat position information can be determined.

Preferably, the converter comprises: a first filter for reducing noise in the ripple signal; a second filter for filtering alternating current components in the ripple signal; and a comparator for comparing the filtered signal from the first filter and the filtered signal from the second filter.

Preferably, the first filter and the second filter are low pass filters and the first filter has a cut-off frequency greater than the second filter.

Preferably, the cut-off frequency of the first filter is greater than a fundamental wave frequency of the ripple signal and lower than twice the fundamental wave frequency of the ripple signal.

Preferably, the cut-off frequency of the second filter is greater than the result of a fundamental wave frequency of the ripple signal divided by the number of magnetic poles of the motor and lower than the fundamental wave frequency of the ripple signal.

Preferably, a switch is connected between the motor and the converter for controlling the rotational direction of the motor.

Preferably, the sampling circuit comprises a resistor connected between the switch and ground.

According to a second aspect, the present invention provides a control device for a vehicle seat, comprising: at least two electric motors for adjusting the seat; a switch for selecting one of the at least two motors to operate; a sampling circuit for generating a ripple signal indicative of a rotational number of the selected motor; a converter for converting the ripple signal to a pulse signal having a frequency proportional to the frequency of the ripple signal; and a controller for counting pulses in the pulse signal such that seat position information can be determined.

Preferably, the converter comprises: a first filter for reducing noise in the ripple signal; a second filter for filtering alternating current components in the ripple signal; and a comparator for comparing the filtered signal from the first filter and the filtered signal from the second filter.

Preferably, the first filter and the second filter are low pass filters and the first filter has a cut-off frequency greater than the second filter.

Preferably, the cut-off frequency of the first filter is greater than a fundamental wave frequency of the ripple signal and lower than twice the fundamental wave frequency of the ripple signal.

Preferably, the cut-off frequency of the second filter is greater than the result of a fundamental wave frequency of the ripple signal divided by the number of magnetic poles of the motor and lower than the fundamental wave frequency of the ripple signal.

Preferably, a second switch is connected between the switch and the converter for controlling the rotational direction of the selected motor.

Preferably, the at least two motors share the second switch.

Preferably, the sampling circuit comprises a resistor connected between the second switch and ground.

According to a third aspect, the present invention provides a method for adjusting the position of a seat moved by at least one electric motor, comprising: converting a ripple signal indicative of a rotational number of the motor to a pulse signal which has a frequency proportional to the frequency of the ripple signal; and counting pulses in the pulse signal such that seat position information can be determined.

Preferably, the ripple signal is converted to the pulse signal by: filtering alternating current components in the ripple signal to produce a filtered signal; and comparing the ripple signal and the filtered signal.

In the present invention, the ripple signal of the motor is converted to a pulse signal which is easier for the controller to process. Further, it is allowable to physically arrange the switches to be close to the controller and remote from the motors. Thus the number of long wires inside the vehicle body may be decreased and a lighter control device is therefore possible.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labelled with a same reference numeral in all the figures in which they appear. Dimensions of components and features shown in the figures are generally chosen for convenience and clarity of presentation and are not necessarily shown to scale. The figures are listed below.

FIG. 1 is a schematic diagram of a control device for a vehicle seat in accordance with the preferred embodiment of the present invention; and

FIG. 2 is a schematic diagram of a converter, being a part of the control device of FIG. 1.

### DETAILED DESCRIPTION OF THE PREFERRED EMBODIMENTS

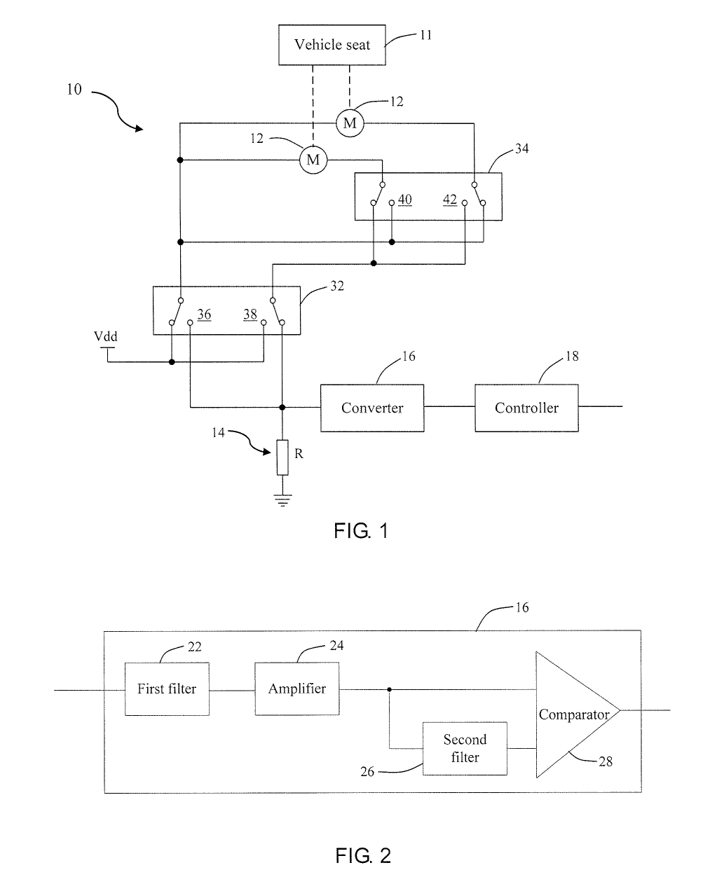

As illustrated in FIG. 1, a control device 10 for a vehicle seat 11 in accordance with the preferred embodiment of the present invention includes electric motors 12 for adjusting the position of the seat 11, a sampling circuit 14 for generating a ripple signal indicative of a rotational number of the motors 12, a converter 16 for converting the ripple signal to a pulse signal which has a frequency proportional to the frequency of the ripple signal, and a controller 18 for counting pulses in the pulse signal such that seat position information can be determined. The motors 12 maybe arranged at different positions inside the seat 11 to move different parts of the seat. To simplify the illustration, only two motors 12 are shown in FIG. 1.

The motor 12 is preferably a brushed direct current motor. Due to commutation, the current of motor 12 has an alternating current component (referred to as ripple current or ripple) superimposed on a direct current component. The frequency of the ripple current is proportional to the rotational number of the motor 12 and the motion or distance of travel of the seat 11 can be therefore determined.

The sampling circuit 14 includes a sampling resistor R connected in series between the motor 12 and ground. Via the sampling resistor R a ripple voltage signal whose frequency is proportional to the rotational number of the motor 12 can be generated.

The converter 16 converts the ripple signal to a pulse signal which has a frequency proportional to the frequency of the ripple signal. Preferably, the pulse signal has the same frequency as the ripple signal.

FIG. 2 is a schematic diagram of the converter 16. The converter 16 includes a first filter 22, an amplifier 24, a second filter 26 and a comparator 28. The first filter 22 eliminates noise in the ripple signal. Preferably, the first filter 22 is a low pass filter and the cut-off frequency of the first filter 22 is greater than the fundamental wave frequency of the ripple signal and lower than twice of the fundamental wave frequency of the ripple signal. The amplifier 24 amplifies the filtered ripple signal from the first filter 22. The second filter 26 filters alternating current components in the amplified ripple signal from the amplifier 24. Preferably, the second filter 26 is a low pass filter and the cut-off frequency of the second filter 26 is greater than the result of the fundamental wave frequency of the ripple signal divided by the number of magnetic poles of the motor and lower than the fundamental wave frequency of the ripple signal. The comparator 28 compares the amplified signal from the amplifier 24 and the filtered signal from the second filter 26 and a pulse signal which has the same frequency as the ripple signal is therefore obtained. It should be understood that the amplifier 24 is preferred but not a must.

The electronic controller 18 counts the pulses in the pulse signal. Thus the rotational information of the rotor of the motor and the corresponding position information of the seat 11 can be determined accordingly.

Referring back to FIG. 1, the control device 10 further includes two switches 32, 34. The switch 32 is connected between the motors 12 and the converter 16 and controls the rotational direction of the motors 12. The switch 32 includes two switching units 36, 38. The switch 34 is connected between the motors 12 and the switch 32 to select one of the motors 12 to operate. The switch 34 includes two switching units 40, 42 respectively connected to the two motors 12. It should be understood that the number of switching units of the switch 34 will increase accordingly if the control device 10 has more motors 12.

Each of the switching units 36, 38, 40, 42 includes a common terminal, and first and second terminals. The first terminal of each switching unit 36, 38 of the switch 32 is connected to the direct current power supply Vdd. The second terminal of each switching unit 36, 38 is connected to the sampling circuit 14. The first terminal of each switching units 40, 42 of the switch 34 is connected to the common terminal of the switching unit 38. Optionally, the second terminal of each switching unit 40, 42 is connected to the common terminal of the switching unit 36. The first terminals of the two motors 12 are connected to the common terminal of the switching unit 36 of the switch 32. The common terminals of the switching units 40, 42 are respectively connected to the second terminals of the two motors 12.

The common terminal of the switching unit 36 is switched to the first terminal connected to the power supply Vdd and the common terminal of the switching unit 38 is switched to the second terminal connected to the sampling circuit 14. The common terminal of the switching unit 40 is switched to the first terminal connected to the common terminal of the switching unit 38, which selects the motor 12 connected to the switching unit 40 to run. The common terminal of the switching unit 42 is switched to the second terminal connected to the common terminal of the switching unit 36, which makes the motor 12 connected to the switching unit 42 non-selected as there is no potential difference between the terminals of this motor.

If the common terminal of the switching unit 36 is switched to be connected to the second terminal while the common terminal of the switching unit 38 is switched to the first terminal, the direction of the current passing through the selected motor will change and the motor will rotate in the opposite direction.

If the common terminal of the switching unit 40 is switched to the second terminal while the common terminal of the switching unit 42 is switched to the first terminal, the motor 12 connected to the switching unit 42 will be selected to operation while the motor 12 connected to the switching unit 40 will not be selected.

In the present invention, the ripple signal of the motor is converted to a pulse signal which is easier for the controller to process. Further, it is allowable to physically arrange the switches 32, 34 to be close to the controller 18 and remote from the motors 12. Thus the number of long wires inside the vehicle body may be decreased and a lighter control system is therefore possible.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

1. A control device for a vehicle seat, comprising:
an electric motor for adjusting the seat;
a sampling circuit for generating a ripple signal indicative of a rotational number of the motor;
a converter for converting the ripple signal to a pulse signal which has a frequency proportional to the frequency of the ripple signal; and
a controller for counting pulses in the pulse signal such that seat position information can be determined.

2. The control device of claim 1, wherein the converter comprises:
a first filter for reducing noise in the ripple signal;
a second filter for filtering alternating current components in the ripple signal; and
a comparator for comparing the filtered signal from the first filter and the filtered signal from the second filter.

3. The control device of claim 2, wherein the first filter and the second filter are low pass filters and the first filter has a cut-off frequency greater than the second filter.

4. The control device of claim 3, wherein the cut-off frequency of the first filter is greater than a fundamental wave frequency of the ripple signal and lower than twice the fundamental wave frequency of the ripple signal.

5. The control device of claim 3, wherein the cut-off frequency of the second filter is greater than the result of a fundamental wave frequency of the ripple signal divided by the number of magnetic poles of the motor and lower than the fundamental wave frequency of the ripple signal.

6. The control device of claim 1, further comprising a switch connected between the motor and the converter for controlling the rotational direction of the motor.

7. The control device of claim 6, wherein the sampling circuit comprises a resistor connected between the switch and ground.

8. A control device for a vehicle seat, comprising:
at least two electric motors for adjusting the seat;
a switch for selecting one of the at least two motors to operate;
a sampling circuit for generating a ripple signal indicative of a rotational number of the selected motor;
a converter for converting the ripple signal to a pulse signal having a frequency proportional to the frequency of the ripple signal; and
a controller for counting pulses in the pulse signal such that seat position information can be determined.

9. The control device of claim 8, wherein the converter comprises:
a first filter for reducing noise in the ripple signal;
a second filter for filtering alternating current components in the ripple signal; and
a comparator for comparing the filtered signal from the first filter and the filtered signal from the second filter.

10. The control device of claim 9, wherein the first filter and the second filter are low pass filters and the first filter has a cut-off frequency greater than the second filter.

11. The control device of claim 10, wherein the cut-off frequency of the first filter is greater than a fundamental wave frequency of the ripple signal and lower than twice the fundamental wave frequency of the ripple signal.

12. The control device of claim 10, wherein the cut-off frequency of the second filter is greater than the result of a fundamental wave frequency of the ripple signal divided by the number of magnetic poles of the motor and lower than the fundamental wave frequency of the ripple signal.

13. The control device of claim 8, further comprises a second switch connected between the switch and the converter for controlling the rotational direction of the selected motor.

14. The control device of claim 13, wherein the at least two motors share the second switch.

15. The control device of claim 13, wherein the sampling circuit comprises a resistor connected between the second switch and ground.

16. A method for adjusting the position of a seat moved by at least one electric motor, comprising:
converting a ripple signal indicative of a rotational number of the motor to a pulse signal which has a frequency proportional to the frequency of the ripple signal; and
counting pulses in the pulse signal such that seat position information can be determined.

17. The method of claim 16, wherein the ripple signal is converted to the pulse signal by:
filtering alternating current components in the ripple signal to produce a filtered signal; and
comparing the ripple signal and the filtered signal.
